(19) United States
(12) Patent Application Publication
(10) Pub. No.: US 2025/0097226 A1
(43) Pub. Date: Mar. 20, 2025

(54) DETECTING DATA EXFILTRATION VIA API CALLS USING LANGUAGE MODEL EMBEDDINGS

(71) Applicant: Cisco Technology, Inc., San Jose, CA (US)

(72) Inventors: Charles Fleming, Oxford, MS (US); Jayanth SRINIVASA, San Jose, CA (US); Ramana Rao V.R. KOMPELLA, Foster City, CA (US)

(21) Appl. No.: 18/368,873

(22) Filed: Sep. 15, 2023

(51) Int. Cl. H04L 9/40; G06F 9/54; G06F 21/62

(52) U.S. Cl. CPC H04L 63/10; G06F 9/547; G06F 21/6245

(57) ABSTRACT

In one implementation, a device intercepts return data for an application programming interface call to be sent to a requester via a network. The device converts the return data into an embedding. The device determines a similarity between the embedding and one or more embeddings in a database that were generated from one or more documents deemed sensitive. The device blocks, based on the similarity, the return data from being sent via the network to the requester.

### TECHNICAL FIELD

The present disclosure relates generally to detecting data exfiltration via application programming interface (API) calls using language model embeddings.

### BACKGROUND

Data exfiltration remains a significant security concern for many enterprise networks. Generally, data exfiltration entails sensitive or otherwise protected data being shared outside of the enterprise or a subset of the enterprise (e.g., a set of authorized users or devices). In some instances, data exfiltration can be attributable to a user who may do so maliciously (e.g., a disgruntled employee) or unintentionally (e.g., an employee uploading a sensitive document to Google Docs for home access, etc.). In other cases, data exfiltration may be due to an enterprise device becoming infected with malware that sends internal data from the enterprise to an external location. In other instances, data exfiltration can be due to coding errors, misconfigurations, etc. in an application or application programming interface (API) server.

Detecting data exfiltration can also be quite difficult, as slight perturbations to the data can avoid mechanisms that seek to match the data being sent externally to the protected data. For instance, consider the case in which an employee makes several changes to a sensitive document before uploading a copy of that document to the cloud. Since the uploaded document has some differences from that of the original copy, a security mechanism that scans for copies of the sensitive document may miss the upload, leading to data exfiltration from the enterprise.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example architecture for detecting data exfiltration via application programming interface (API) calls using language model embeddings; and

FIG. 4 illustrates an example simplified procedure for detecting data exfiltration via API calls using language model embeddings.

### DESCRIPTION OF EXAMPLE IMPLEMENTATIONS

### Overview

According to one or more implementations of the disclosure, a device intercepts return data for an application programming interface call to be sent to a requester via a network. The device converts the return data into an embedding. The device determines a similarity between the embedding and one or more embeddings in a database that were generated from one or more documents deemed sensitive. The device blocks, based on the similarity, the return data from being sent via the network to the requester.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

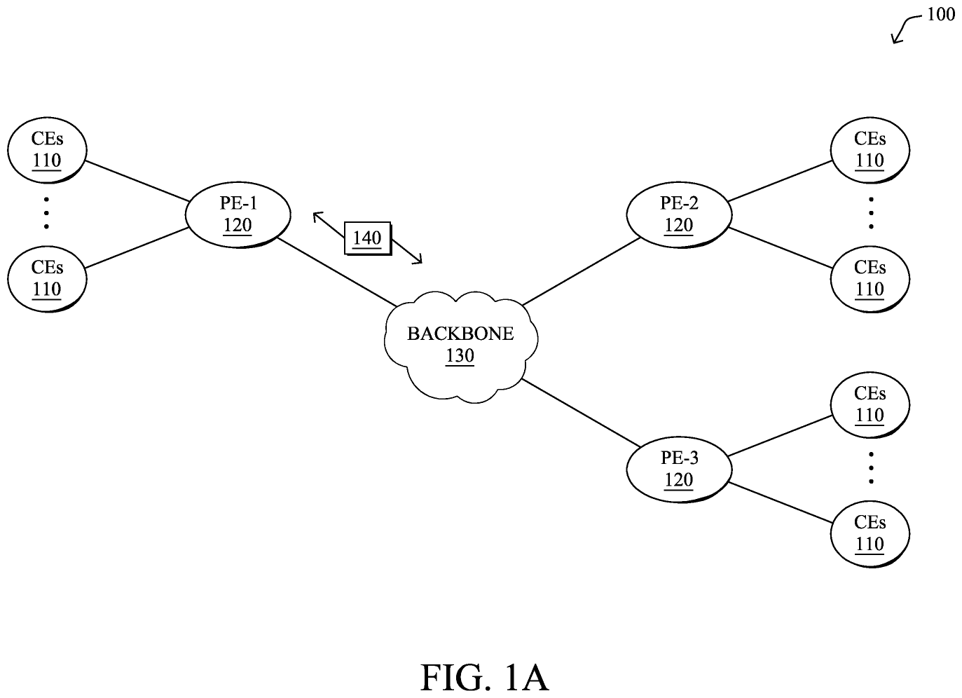

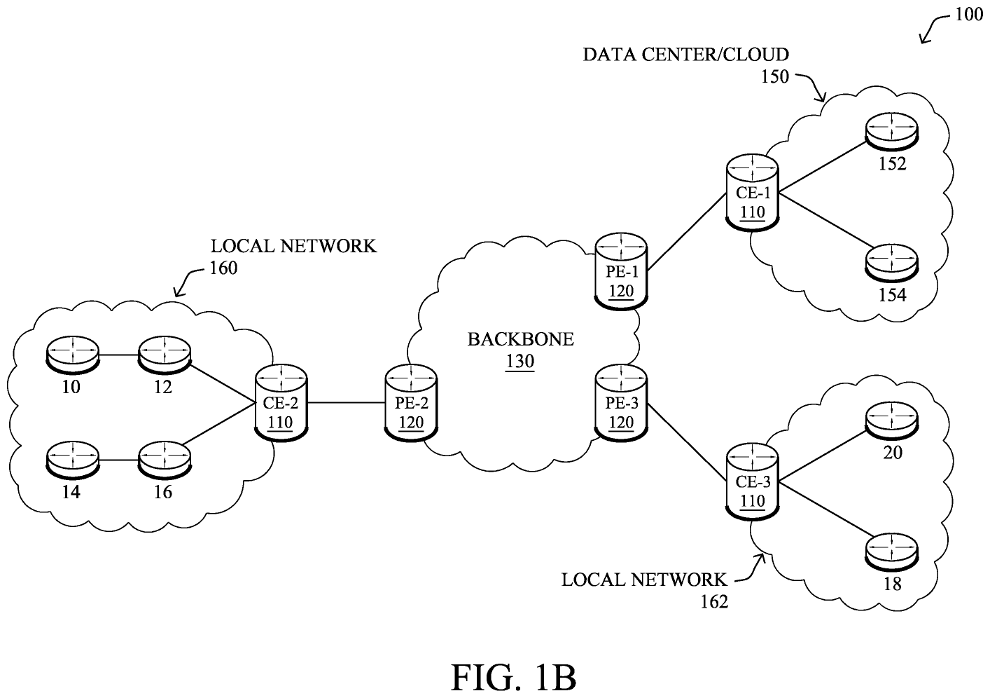

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in computer network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to computer network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of computer network 100 in greater detail, according to various implementations. As shown, network backbone 130 may provide connectivity between devices located in different geographical areas and/or different types of local networks. For example, computer network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, computer network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in computer network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in network backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

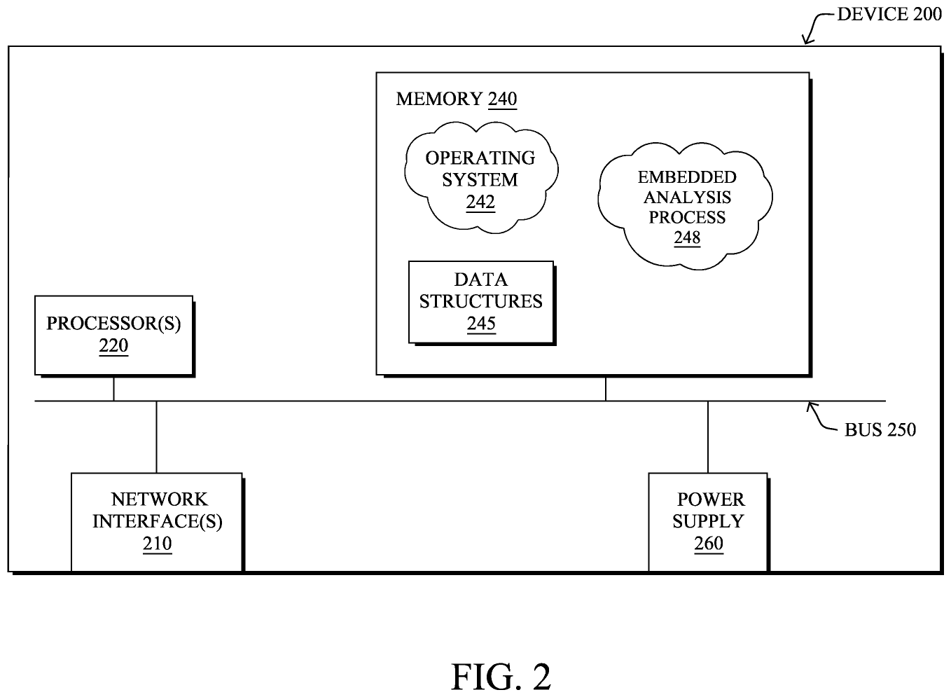

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of computer network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the computer network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise an embedding analysis process 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, embedding analysis process 248 may include computer executable instructions that, when executed by processor(s) 220, cause device 200 to perform the techniques described herein. To do so, in some implementations, embedding analysis process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, embedding analysis process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that embedding analysis process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, embedding analysis process 248 may also include one or more generative artificial intelligence (AI)/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, data exfiltration remains a significant security concern for many enterprise networks. Generally, data exfiltration entails sensitive or otherwise protected data being shared outside of the enterprise or a subset of the enterprise (e.g., a set of authorized users or devices). In some instances, data exfiltration can be attributable to a user who may do so maliciously (e.g., a disgruntled employee) or unintentionally (e.g., an employee uploading a sensitive document to Google Docs for home access, etc.). In other cases, data exfiltration may be due to an enterprise device becoming infected with malware that sends internal data from the enterprise to an external location. In other instances, data exfiltration can be due to coding errors, misconfigurations, etc. in an application or application programming interface (API) server.

Detecting data exfiltration can also be quite difficult, as slight perturbations to the data can avoid mechanisms that seek to match the data being sent externally to the protected data. For instance, consider the case in which an employee makes several changes to a sensitive document before uploading a copy of that document to the cloud. Since the uploaded document has some differences from that of the original copy, a security mechanism that scans for copies of the sensitive document may miss the upload, leading to data exfiltration from the enterprise.

### ——Detecting Data Exfiltration Via API Calls Using Language Model Embeddings——

The techniques introduced herein aid in the detection of data exfiltration via application programming interface (API) calls using language model embeddings. In some aspects, a language model may convert sensitive documents in an enterprise into embeddings that are then stored in a database. In turn, when an API call is made, the system may compare an embedding of the return data to those in the database. If there is a similarity match, then the system may block the return data from being sent. Thus, the system may prevent sensitive data from being exfiltrated, even if it does not exactly match that of a document deemed sensitive.

Illustratively, the techniques described herein may be performed by hardware, software, and/or firmware, such as in accordance with embedding analysis process 248, which may include computer executable instructions executed by the processor 220 (or independent processor of interfaces 210) to perform functions relating to the techniques described herein.

Specifically, according to various implementations, a device intercepts return data for an application programming interface call to be sent to a requester via a network. The device converts the return data into an embedding. The device determines a similarity between the embedding and one or more embeddings in a database that were generated from one or more documents deemed sensitive. The device blocks, based on the similarity, the return data from being sent via the network to the requester.

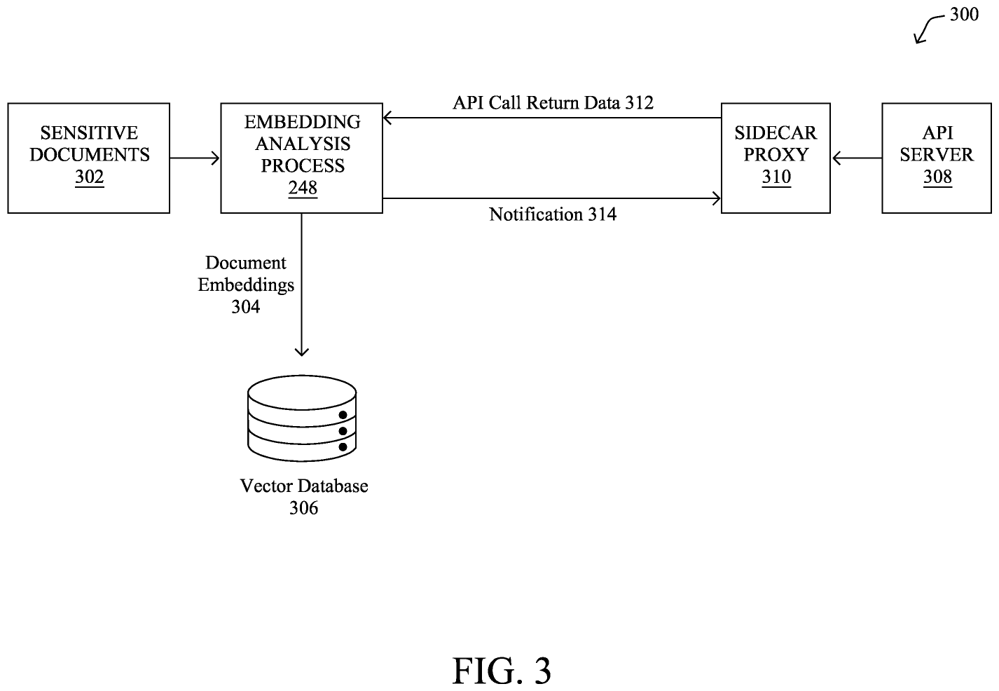

Operationally, FIG. 3 illustrates an example architecture 300 for detecting data exfiltration via application programming interface (API) calls using language model embeddings. At the core of architecture 300 is embedding analysis process 248, which may be executed by a singular device (e.g., device 200) or in a distributed manner across any number of such devices. In the distributed case, the combination of executing devices can also be viewed as a singular device for purposes of the teachings herein.

Today, many applications are executed in cloud-hosted environments, which allows different workloads of an application to be executed in software containers. As would be appreciated, software containers are a tool used to virtualize a computing environment, including the operating system, allowing different (micro-) services/workloads to be executed by the same node in an isolated manner. For instance, different (micro-) services/workloads of an application may be executed across n-number of nodes/devices within a containerized environment.

Management of a containerized environment may be performed by any number of platforms that control different aspects of the containerized environment. For instance, a containerized environment may be implemented using Kubernetes, which is an orchestration system for containerized applications and in charge of managing a cluster of nodes. Similarly, a containerized environment may also be implemented in part using Istio, which is a service mesh platform that controls how (micro-) services share data with one another. Often, Kubernetes and Istio are used together, to deploy an application in a cloud environment, in a containerized manner. Of course, in other embodiments, a containerized environment may be implemented using other utilities, as desired.

As shown, assume that there is an API server 308, which may be executed by a node in a containerized environment. For instance, API server 308 may be a component of a cloud-hosted application executed by a node in a service mesh. During execution, API server 308 may receive an API call from a requester device via a computer network, such as to retrieve certain information via the application. Such functionality, though, presents a potential security risk, as the API served by API server 308 could potentially expose sensitive information that is to be protected from being exfiltrated.

As would be appreciated, sensitive data may take various forms including, but not limited to, personally identifiable information (PII) data, financial information, medical records, trade secrets, attorney-client protected information, sales data, engineering designs, and the like. For instance, assume that there is a set of one or more documents 302 that include such information and have been flagged as such.

In one implementation, the designation of the set of one or more documents 302 as sensitive may be made via a user interface. For instance, a security administrator, a document creator, or other interested user may flag a given document in the set of one or more documents 302 as being sensitive and subject to protection from being exfiltrated. In another implementation, a given document in the set of one or more documents 302 may be flagged as including sensitive data in an automated manner. For instance, a given document may be flagged as sensitive based on a scan of its contents, an identity of its creator, the application in which it was created (e.g., CAD files), or other such factors.

Assume now that a given API call made to API server 308 results in the creation of API call return data 312. Traditionally, API server 308 would send API call return data 312 on to its requester, once generated. However, doing so may also inadvertently leak sensitive information outside of the enterprise. Accordingly, as shown, API server 308 may instead send API call return data 312 first to embedding analysis process 248 for evaluation.

In some implementations, embedding analysis process 248 may be executed in whole, or in part, in a sidecar proxy 310 associated with API server 308. More specifically, in many containerized environments such as Kubernetes, a sidecar proxy is a separate container that runs alongside that of another container, allowing for certain functions to be offloaded from that container (e.g., the container in which API server 308 is executed). For instance, sidecar proxies are often used to perform routing functions, encryption/decryption functions, and the like. Here, one such function that sidecar proxy 310 may also perform relates to preventing API server 308 from sending API call return data 312 to a requester when it includes sensitive data that is to be protected.

To determine whether API call return data 312 includes sensitive data, embedding analysis process 248 may include a trained language model, such as an LLM or other suitable artificial intelligence-based model that takes text as input and generates an embedding that contains a summary of the contents of that text. Accordingly, embedding analysis process 248 may apply its language model to API call return data 312, to convert it into such an embedding.

In some cases, API call return data 312 may also take the form of media data from which embedding analysis process 248 may extract the text for input to its language model. For instance, API call return data 312 may include image, video, and/or audio data. In such a case, embedding analysis process 248 may perform optical character recognition (OCR) on any such images or video, speech-to-text recognition on any audio, or the like, to extract the text for conversion into an embedding.

Once embedding analysis process 248 has converted API call return data 312 into an embedding, it may compare that embedding to any number of embeddings stored in a database 306. In some instances, database 306 may take the form of a vector database, although other suitable forms of databases may also be used.

As shown, database 306 may be populated with embeddings formed by inputting the set of one or more documents 302 to a language model, such as the language model of embedding analysis process 248. Consequently, the resulting embeddings 304 stored in database 306 will represent the set of one or more documents 302 and their contents.

By comparing the embedding generated from API call return data 312 to those embeddings in database 306, embedding analysis process 248 can determine a measure of the similarity between the text from API call return data 312 to that in the set of one or more documents 302. For instance, such similarity metrics may take the form of Euclidean distances, cosine distances, or other similarity metrics. Thus, if the measure of similarity exceeds a predefined threshold, embedding analysis process 248 may determine that the text of API call return data 312 is also sensitive and should be blocked. Conversely, if the measure of similarity is below such a threshold, embedding analysis process 248 may determine that API call return data 312 does not include sensitive information and can be passed onward to the API requester.

Once embedding analysis process 248 has completed its analysis, it may send a notification 314 back to sidecar proxy 310 indicative of its determination. If notification 314 indicates that API call return data 312 includes sensitive data, sidecar proxy 310 may then block API call return data 312 from being sent via the network to the requester that sent the API call to API server 308 for API call return data 312. Otherwise, sidecar proxy 310 may allow API call return data 312 to be sent to the requester.

As would be appreciated, the approach shown in FIG. 3 requires only minimal computation to add embeddings for new documents to database 306, which can be updated over time as needed. For instance, a given document in the set of one or more documents 302 may be ‘declassified’ by removing its embedding from database 306. Similarly, a new document deemed sensitive may also be protected from being exfiltrated by adding its embedding to database 306, either by request or automatically, using the above techniques.

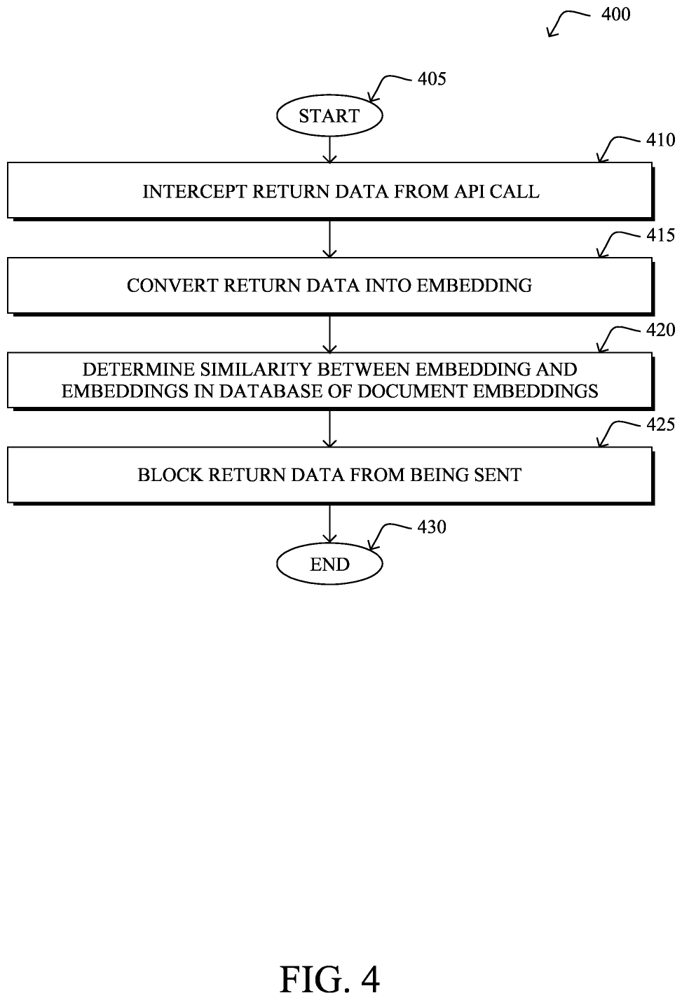

FIG. 4 illustrates an example simplified procedure 400 (e.g., a method) for detecting data exfiltration via application programming interface (API) calls using language model embeddings, in accordance with one or more implementations described herein. For example, a non-generic, specifically configured device (e.g., device 200), such as a router, firewall, controller for a network, server, or the like, may perform procedure 400 by executing stored instructions (e.g., embedding analysis process 248). The procedure 400 may start at step 405, and continues to step 410, where, as described in greater detail above, the device may intercept a return data for an application programming interface call to be sent to a requester via a network. In some implementations, the device is located in a service mesh. In various embodiments, the return data is intercepted by a sidecar proxy associated with a service or microservice that receives the application programming interface call.

At step 415, as detailed above, the device may convert the return data into an embedding. In various implementations, the device may do so by inputting the return data into an artificial intelligence-based language model trained to convert text into embeddings.

At step 420, the device may determine a similarity between the embedding and one or more embeddings in a database that were generated from one or more documents deemed sensitive. In various embodiments, the device may also generate, using the artificial intelligence-based language model, the one or more embeddings from the one or more documents deemed sensitive, and store the one or more embeddings in the database. In some instances, the one or more documents were flagged as sensitive via a user interface. In one implementation, the database is a vector database. In some cases, the one or more documents include personally identifiable information. In various implementations, the similarity comprises a Euclidean distance or cosine similarity.

At step 425, as detailed above, the device may block, based on the similarity, the return data from being sent via the network to the requester. In some implementations, the device may do so by sending a notification to the sidecar proxy indicative to block the return data from being sent.

Procedure 400 then ends at step 430.

It should be noted that while certain steps within procedure 400 may be optional as described above, the steps shown in FIG. 4 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for detecting data exfiltration via API calls using language model embeddings, it is to be understood that various other adaptations and modifications may be made within the spirit and scope of the implementations herein. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
intercepting, by a device, return data for an application programming interface call to be sent to a requester via a network;
converting, by the device, the return data into an embedding;
determining, by the device, a similarity between the embedding and one or more embeddings in a database that were generated from one or more documents deemed sensitive; and
blocking, by the device and based on the similarity, the return data from being sent via the network to the requester.

2. The method as in claim 1, wherein the device is located in a service mesh.

3. The method as in claim 1, wherein the return data is intercepted by a sidecar proxy associated with a service or microservice that receives the application programming interface call.

4. The method as in claim 3, wherein blocking the return data from being sent via the network to the requester comprises:
sending a notification to the sidecar proxy indicative to block the return data from being sent.

5. The method as in claim 1, wherein converting the return data into the embedding by:
inputting the return data into an artificial intelligence-based language model trained to convert text into embeddings.

6. The method as in claim 5, further comprising:
generating, by the device and using the artificial intelligence-based language model, the one or more embeddings from the one or more documents deemed sensitive; and
storing the one or more embeddings in the database.

7. The method as in claim 1, wherein the one or more documents were flagged as sensitive via a user interface.

8. The method as in claim 1, wherein the database is a vector database.

9. The method as in claim 1, wherein the one or more documents include personally identifiable information.

10. The method as in claim 1, wherein the similarity comprises a Euclidean distance or cosine similarity.

11. An apparatus, comprising:
one or more network interfaces;
a processor coupled to the one or more network interfaces and configured to execute one or more processes; and
a memory configured to store a process that is executable by the processor, the process when executed configured to:
intercept a return data for an application programming interface call to be sent to a requester via a network;
convert the return data into an embedding;
determine a similarity between the embedding and one or more embeddings in a database that were generated from one or more documents deemed sensitive; and
block, based on the similarity, the return data from being sent via the network to the requester.

12. The apparatus as in claim 11, wherein the apparatus is located in a service mesh.

13. The apparatus as in claim 11, wherein the return data is intercepted by a sidecar proxy associated with a service or microservice that receives the application programming interface call.

14. The apparatus as in claim 13, wherein the apparatus blocks the return data from being sent via the network to the requester by:
sending a notification to the sidecar proxy indicative to block the return data from being sent.

15. The apparatus as in claim 11, wherein the apparatus converts the return data into the embedding by:
inputting the return data into an artificial intelligence-based language model trained to convert text into embeddings.

16. The apparatus as in claim 15, wherein the process when executed is further configured to:
generate, using the artificial intelligence-based language model, the one or more embeddings from the one or more documents deemed sensitive; and
store the one or more embeddings in the database.

17. The apparatus as in claim 11, wherein the one or more documents were flagged as sensitive via a user interface.

18. The apparatus as in claim 11, wherein the database is a vector database.

19. The apparatus as in claim 11, wherein the one or more documents include personally identifiable information.

20. A tangible, non-transitory, computer-readable medium storing program instructions that cause a device to execute a process comprising:
intercepting, by the device, return data for an application programming interface call to be sent to a requester via a network;
converting, by the device, the return data into an embedding;
determining, by the device, a similarity between the embedding and one or more embeddings in a database that were generated from one or more documents deemed sensitive; and
blocking, by the device and based on the similarity, the return data from being sent via the network to the requester.
